(19) United States
(12) Patent Application Publication
(10) Pub. No.: US 2003/0018576 A1
(43) Pub. Date: Jan. 23, 2003

(54) Risk evaluation system and method

(75) Inventors: Kenneth Zuckerbrot, New York, NY (US); Jeffrey D. Mamorsky, Greenwich, CT (US); Robert T. Bossart, Rockville Center, NY (US)

Correspondence Address: GREENBERG-TRAURIG, 1750 TYSONS BOULEVARD, 12TH FLOOR, MCLEAN, VA, 22102, US

(73) Assignee: BOMAZU, LLC, New York, NY

(21) Appl. No.: 10/178,776

(22) Filed: Jun. 25, 2002

Related U.S. Application Data
(60) Provisional application No. 60/300,729, filed on Jun. 25, 2001.

(51) Int. Cl. G06F 17/60

(52) U.S. Cl. 705/38

(57) ABSTRACT

Disclosed is a method for increasing earnings per share for a taxpayer without revealing attorney-client or work product privileged information. In one embodiment, the method includes the steps of: determining a tax reserve amount in connection with a transfer pricing transaction in a tax period; reserving a tax reserve for financial statement purposes, the amount of the tax reserve being equal to the determined tax reserve amount; obtaining an insurance product from an insurer, the insurance product insuring a portion of the tax reserve amount and being issued by the insurer without the insurer reviewing attorney-client or work product privileged information; and reversing to income, for financial statement purposes, the tax reserve amount that is insured by the insurance product. In another embodiment, the invention provides a method for determining whether an application to insure a given amount in connection with a transfer pricing transaction for a given taxation period constitutes an insurable risk.

This application claims the benefit of U.S. Provisional Patent Application No. 60/300,729 filed Jun. 25, 2001, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to a risk evaluation system and method, and more particularly to a system and method for evaluating the insurability risk of a company's transfer pricing tax reserves for a particular country in a specific year.

### BACKGROUND OF THE INVENTION

Transfers of goods, services, intangible property, and capital between unrelated companies at prices based on market conditions (the “arm's length standard”) are well known, as are transfers between members of a multinational group (“related parties”). The price used by the related parties to make such transfers (the “transfer price” or the “intercompany price”) has been of concern to some tax authorities for almost as long as taxing jurisdictions have taxed the net income of corporations doing business in their jurisdiction. The concern exists because different tax jurisdictions have different tax systems and rates. As a result, tax authorities have been concerned that related parties do not use transfer prices among members of the group that reflect the arm's length standard that unrelated parties would use. In such cases, profits may be artificially shifted from a high tax jurisdiction to a low tax jurisdiction or from a tax paying company to a company with tax loss carryovers to reduce the tax on those profits for the benefit of the related party group.

Governments have been confronted by two key issues concerning the potential for abuses they perceived with transfer pricing. The first is the difficulty associated with enacting laws and rules or regulations to define a locally acceptable and enforceable “arm's length standard.” The second is the problem of obtaining sufficient information on a timely basis from a taxpayer under examination to fairly evaluate the company's transfer pricing policies and/or results (“Contemporaneous Documentation”).

In this regard, the United States has been a leader in addressing each of these issues. The section on inter-company pricing below discusses the development of the U.S. transfer pricing law, policy, and regulations over the past 80 years. Today most of the industrialized world and even many emerging countries have some body of transfer pricing law and rules that range from very simple to very complex. The section on contemporaneous documentation below discusses the evolution of the “Contemporaneous Documentation” rules adopted by the United States in the last decade to address the timely taxpayer information issue. At its essence, the contemporaneous documentation rules require taxpayers (1) to prepare an economic analysis study which supports the transfer pricing result contained in the tax return at the time the tax return is filed; (2) use a person qualified to perform such an analysis; and (3) provide a copy of that analysis to the examining agents of the U.S. Internal Revenue Service (“IRS”) within 30 days of their request for it. Failure to do so means that any transfer pricing adjustment above certain thresholds will result in non-deductible penalties of 20% or 40% of the additional tax due based on the transfer pricing adjustment. Proper documentation delivered on a timely basis will prevent the application of such transfer pricing penalties from being assessed even if an actual transfer pricing adjustment exceeds the formulaic thresholds and increase the company's tax liability beyond that contained in the original or amended tax return as filed which is currently under examination. Again, many other countries have adopted similar contemporaneous documentation rules or are currently considering them.

However, even in a marketplace of unrelated parties, some buyers pay more than they should, and some sellers receive less than they might have received. This occurs because markets are constantly changing, and in most cases specific, unchanging price lists or formulae do not exist. As a result, multinational groups have grown increasingly concerned that taxing jurisdictions will artificially shift profits to their jurisdiction in order to raise more tax revenues even if the transfer prices used in related party transactions were reasonable under the circumstances.

These concerns have caused companies to make increases to the tax provision in their financial statements beyond the amount the company expects to pay in a particular tax jurisdiction based on the taxable income reported in its tax return. These “transfer pricing tax reserves” represent the additional amount of tax that the company estimates may result from a dispute with a tax authority over the transfer prices for related party transactions reported in a tax return under examination by that tax jurisdiction. Such increases reduce the company's net income and earnings per share. FIG. 1 below is a flow-chart of the process by which a company establishes and reduces transfer pricing tax reserves.

Therefore, some companies engage outside tax counsel who engage “transfer pricing” economists to help the company establish, change, or evaluate its existing transfer pricing policies for the purpose of determining how much, if any, additional transfer pricing tax reserve the company may need to provide. Normally, such legal tax advice enjoys protection from discovery by tax authorities under the “attorney-client privilege” and “work product” doctrines. Other companies use non-legal outside consultants such as public accounting firms or economic consulting firms to perform such analysis. Still others do such analysis using company personnel. It is well known to one of skill in the art that the amount of a tax reserve is privileged. Were it not, it is believed that a taxing authority would simply discover the tax reserved amount, request the calculations used to determine the amount, and base its decision on what would be held out as if it were a party admission. To encourage responsible accounting, and reserving, a taxpayer's tax reserve is, under proper conditions, privileged information, and generally not properly discoverable by the taxing authorities.

Nevertheless, companies still provide such additional tax reserves to the detriment of their financial statements for two reasons. First, in the absence of specific, government approved price lists or formulae, there continues to be considerable uncertainty regarding how various taxing jurisdictions will react to the related party group's transfer prices. Second, for the reasons set forth below, no insurance company was willing to provide insurance or reinsurance for part or all of the transfer pricing tax reserve even though such disputes have existed for almost 80 years in the United States and similar periods in other tax jurisdictions that tax corporations on their net income.

To underwrite such insurance or reinsurance, the company would need to provide a sufficient amount of information for the insurance company, underwriter, or a third party to be able to evaluate whether the company had an insurable risk and, if so, the amount and conditions that should attach to such insurance or reinsurance. Companies would not provide such information to the insurance company for fear of waiving the privilege attached to the tax advice that helped them establish their transfer pricing tax reserves or otherwise creating a body of publicly available information discoverable by a taxing authority and used as a “road map” to make additional tax assessments. Without sufficient information provided by the company to evaluate the insurable risk, amount, and related conditions for such insurance or reinsurance, no insurance company would provide such coverage for transfer pricing tax reserves.

Intercompany Pricing

Among other nations which examine a multinational's intercompany pricing, the United States enacted its corporate income tax in 1913 and, as early as 1921, Congress perceived the potential for abuse among related taxpayers engaged in related party transactions. See, e.g., Internal Revenue Service Notice, A Study of Intercompany Pricing under section 482 of the Code, Notice 88-123, at 6 (1988). Although Congress immediately drafted legislation to address this problem, the initial legislation drafted was deemed excessive because it gave the Commissioner of the Internal Revenue Service (“IRS”) the power to actually prepare consolidated returns for commonly-owned business that normally filed separate tax returns or to recompute their tax liabilities “whenever necessary”. Therefore, Congress revised and improved upon these proposals over the next few years until the Revenue Act of 1928, when section 45 was finally incorporated into the Internal Revenue Code. Specifically designed for intercompany pricing situations, this provision gave the Commissioner of the Internal Revenue Service (“IRS”) the authority to make adjustments expressly predicated on a duty to prevent tax avoidance and to help determine a company's “true tax liability.”

For the next forty years, this provision remained relatively unchanged, continuing as section 45 of the Internal Revenue Code of 1939 and renumbered as section 482 of the Internal Revenue Code of 1954. Similarly, a 1935 income tax regulation, setting forth the “arm's length standard” as a principle basis for transfer pricing adjustments, remained in effect and substantially unchanged until 1968. Yet due to the nature of the American economy, it was primarily applied to domestic corporations. By the 1960's, the business and regulatory climate in which U.S. and multinational corporations operated changed dramatically. It became apparent that a newer version of section 482 was needed, both to adapt to the changing economic environment and to rectify some of the shortcomings in the existing statute.

Congress and the Treasury responded with the 1962 Revenue Bill, which called for amendments to section 482's regulations. These revised income tax regulations established new rules for specific kinds of intercompany transfers by addressing the issues of the performance of services, licensing or sale of intangible property and sale of tangible property. Where earlier versions of section 482 were used to prevent the mismatching of expenses and recognition of unwarranted losses from tax-free transfers, the revised regulations that were finalized in 1968 were aimed at preventing the “evasion of taxes” through a “clear reflection of income.” Also, 1964 marked the first time that the Tax Court relied on section 482 to combine the incomes of two separate businesses in order to compute taxable income. With few exceptions, the 1968 regulations governed transfer pricing analysis and disputes for the next 25 years.

Despite these changes made to section 482, the regulations still provided little guidance for determining transfer prices in the absence of comparables. Specifically, in the 1970's and 80's, two main problems were identified by the U.S. Government in relation to section 482. The first problem was the IRS's difficulty in obtaining pricing information from the taxpayer during an examination. Several factors, including the taxpayer's inability or unwillingness to furnish all relevant information, as well as the long delays between the request and the actual production of information were attributed to this problem.

The second problem was the difficulty of valuing intangibles, including intangible property in connection with the sale of tangible property. The intangible property portion of the 1968 regulations identified twelve factors to be considered when there was a lack of appropriate comparables to use as a guide. Some situations also forced examiners to rely on different sections to make transfer pricing adjustments. As a result, problems with intangibles became the foundation for Congress' amendments to section 482 in the Tax Reform Act of 1986.

The 1986 Act amended section 482 to require that payments to a related party with respect to a licensed or transferred intangible be “commensurate with the income” attributable to the intangible. This change reflected a Congressional concern that the arm's length standard, as interpreted in case law, failed to allocate to U.S. related parties an appropriate amount of income derived from those intangibles. Through the 1986 changes, Congress also intended to permit bona fide cost-sharing arrangements while ensuring that the economic results from such an arrangement were consistent with the commensurate with income standard.

Subsequently, the U.S. Treasury and IRS established almost completely revised transfer pricing rules through the release of Proposed Regulations in 1992, Temporary Regulations in 1993, and the currently applicable Final Regulations released in 1994. The new rules have a much greater focus on comparability, specific acceptable methods, and creating ranges of acceptable results.

Contemporaneous Documentation

Before the Revenue Reconciliation Act of 1989, separate sections of U.S. tax law imposed separate penalties on understatements due to negligence (or disregard of rules or regulation), substantial understatements of tax liability, valuation overstatements for income tax purposes, overstatements of pension liabilities, and valuation understatements for purposes of estate of gift taxes. These penalties could be applied cumulatively, so that a single act or transaction was sometimes subject to multiple penalties. Congress believed that this “stacking” of penalties was inappropriate and created administrative difficulties for the IRS.

As a result, the 1989 act revised and consolidated these penalties in section 6662, effective for returns due (without regard to extensions) after Dec. 31, 1989. The law consolidated into one part of the Internal Revenue Code all of the generally applicable penalties relating to the accuracy of tax returns. The penalties that were consolidated included the negligence penalty, the substantial understatement penalty, and the valuation penalties. These consolidated penalties were also coordinated with the fraud penalty. The new law also reorganized the accuracy penalties into a new structure that operated to eliminate any stacking of the penalties.

From a transfer pricing perspective, as revised in 1993, a “substantial valuation misstatement” as defined in section 6662(e) occurs if (1) the consideration reflected in the return for a transaction between related persons is 200 percent or more of the amount ultimately determined to be correct under section 482 or is 50 percent or less of the price after the section 482 adjustment or (2) the “net section 482 transfer price adjustment” for the taxable year exceeds the lesser of $5 million or 10% of the taxpayer's gross receipts.

In addition, the penalty rate of 20 percent is doubled to 40 percent for the portion of an underpayment that is attributable to “gross valuation misstatements” as defined in section 6662(h). A gross valuation misstatement occurs if (1) the reported value or adjusted basis of property is 400 percent or more of the correct amount, (2) a price reflected on the taxpayer's return is 400 percent or more or 25 percent of less of the amount determined to be correct after adjustment under section 482, or (3) the net section 482 transfer price adjustment for the year exceeds the lesser of $20 million or 20% of the taxpayer's gross receipts.

As noted in the law, and expanded in detail in U.S. Income Tax Regulation section 1.6662-6, the taxpayer must have specifically defined types of documentation generated by the Company and/or a qualified outside professional (as defined) available as of the date of filing the tax return and turn it over to the IRS within 30 days of the IRS' request for it. Otherwise, such “contemporaneous documentation” will be ignored and penalties may apply to any transfer pricing adjustments that otherwise meet the substantial valuation misstatement or gross valuation misstatement tests.

Despite the existence of corporate taxation for almost a century, provisions for adjustments resulting from transfer pricing transactions for almost as long, and even the present contemporaneous documentation regulations for substantially more than a decade, a taxpayer was heretofore unable to obtain insurance for its tax reserve. There is a need for an insurance product, and a corresponding method of determining the risk associated with the issuance thereof, where the insurance can be provided without the need for disclosure of privileged information.

### OBJECTS AND SUMMARY OF THE INVENTION

It is therefore an object of the invention to provide a method for insuring a taxpayer's tax reserves without the need for waiving or otherwise breaching the attorney-client, work product, or similar privilege.

It is a further object of the invention to provide a method of evaluating the magnitude and/or insurability of a risk of upward adjustment to the amount of tax reported by a taxpayer.

It is a further object of the invention to provide method for decreasing tax reserves by insuring them without the need for a disclosure of privileged information.

It is yet a further object of the invention to provide a method for increasing net income for a reported period by insuring at least a portion of tax reserves without the need for a disclosure of privileged information.

In a preferred embodiment, the invention provides a method for increasing earnings per share for a taxpayer without revealing attorney-client or work product privileged information, the method comprising the steps of: determining a tax reserve amount in connection with a transfer pricing transaction in a tax period; reserving a tax reserve for financial statement purposes, the amount of the tax reserve being equal to the determined tax reserve amount; obtaining an insurance product from an insurer, the insurance product insuring a portion of the tax reserve amount and being issued by the insurer without the insurer reviewing attorney-client or work product privileged information; and reversing to income, for financial statement purposes, the tax reserve amount that is insured by the insurance product.

Another aspect of the invention provides a method of increasing earnings per share for a taxpayer without revealing privileged information, the method comprising the steps of: determining a tax reserve amount in connection with a taxable transaction in a tax period; reserving a tax reserve for financial statement purposes, the amount of the tax reserve being equal to the determined tax reserve amount; obtaining an insurance product from an insurer, the insurance product insuring a portion of the tax reserve amount and being issued by the insurer without the insurer reviewing privileged information; and reversing to income, for financial statement purposes, at least a portion of the tax reserve amount that is insured by the insurance product.

In yet another aspect of the present invention, a method is provided for determining whether an application to insure a given amount in connection with a transfer pricing transaction for a given taxation period constitutes an insurable risk, the method comprising the steps of: obtaining from a taxpayer contemporaneous documentation related to a transfer pricing transaction; determining what publicly available information is relevant to the transfer pricing transaction; obtaining at least a portion of the relevant publicly available information; determining a transfer price range of acceptable results without reliance upon privileged information of the taxpayer, the determination being based upon information comprising the contemporaneous documentation and the obtained publicly available information; assessing a likelihood and likely magnitude of an upward adjustment to the taxpayer's income reported in connection with the transfer pricing transaction in the event that the taxpayer is examined by a tax authority; and determining whether the requested insurance amount constitutes an insurable risk in light of the assessed likelihood and likely magnitude of an upward adjustment.

The foregoing aspect may include a step of determining an additional retention amount that would permit the requested insurance amount to constitute an insurable risk.

In another aspect of the present invention, a method is provided for determining a premium in connection with an insurance application for a requested amount of insurance and retention amount in connection with a taxable transaction for a given taxation period, the method comprising the steps of: receiving an insurance application for a requested amount of insurance and retention amount in connection with a taxable transaction for a given taxation period, the insurance application including contemporaneous documentation related to the taxable transaction; determining what publicly available information is relevant to the taxable transaction, and obtaining at least a portion of the relevant publicly available information; assessing a likelihood and likely magnitude of an upward adjustment to the taxpayer's income reported in connection with the taxable transaction in the event that the taxpayer is examined by a tax authority; and calculating a premium based, at least in part, upon the requested amount of insurance and retention amount, and the assessed likelihood and likely magnitude of an upward adjustment to the taxpayer's income reported.

In another aspect of the invention, the method of determining a premium may include obtaining a history for the taxpayer with respect to previous transfer pricing matters, for at least one previous period; determining a taxpayer risk factor relative to the history; and adjusting the premium as a function of the taxpayer risk factor.

Yet another aspect of the invention involves a method of qualifying an insurance application for a requested amount of insurance and retention amount in connection with a taxable transaction for a given taxation period, the method comprising the steps of: receiving an insurance application for a requested amount of insurance and retention amount in connection with a taxable transaction for a given taxation period, the insurance application including contemporaneous documentation related to the taxable transaction; determining what publicly available information is relevant to the transfer pricing transaction, and obtaining at least a portion of the relevant publicly available information; assessing a likelihood and likely magnitude of an upward adjustment to the taxpayer's income reported in connection with the taxable transaction; obtaining a history for the taxpayer with respect to prior taxable transactions for at least one previous period; determining a taxpayer risk factor relative to the history; calculating an expected cost of an insurance policy for the requested amount of insurance and retention amount, the expected cost being based, at least in part, upon the requested amount of insurance and retention amount, the assessed likelihood and likely magnitude of an upward adjustment to the taxpayer's income reported and the taxpayer risk factor; and qualifying the insurance application if the expected cost of the insurance policy is greater than the premium as adjusted by a predetermined value. The predetermined value may be expressed as a percentage of the premium. In another embodiment, the percentage of the premium can vary with respect to the amount of insurance.

In another aspect of the invention, there is provided a method of performing a tax reserve risk analysis without violating the Company's privileged communication with legal counsel, the method comprising the steps of: creating a questionnaire; obtaining relevant contemporaneous documentation; analyzing the questionnaire and contemporaneous documentation for risk characteristics and quantification; implementing a formula calculation of the retention amount after performing the analysis; and providing a report of the risk evaluation.

The above, and other objects, features and advantages of the invention, will be apparent in the following detailed descript of certain illustrative embodiments thereof, which is to be read in connection with the accompanying drawings forming a part hereof.

### BRIEF DESCRIPTION OF THE DRAWINGS

The foregoing and other objects, features, and advantages of the invention will be apparent from the following more particular description of preferred embodiments as illustrated in the accompanying drawings:

FIGS. 1A through 1D show a high level flow diagram illustrating a method of transfer pricing tax reserve establishment and reduction.

FIG. 2A through 2D show a high level flow diagram illustrating a risk evaluation process for transfer pricing.

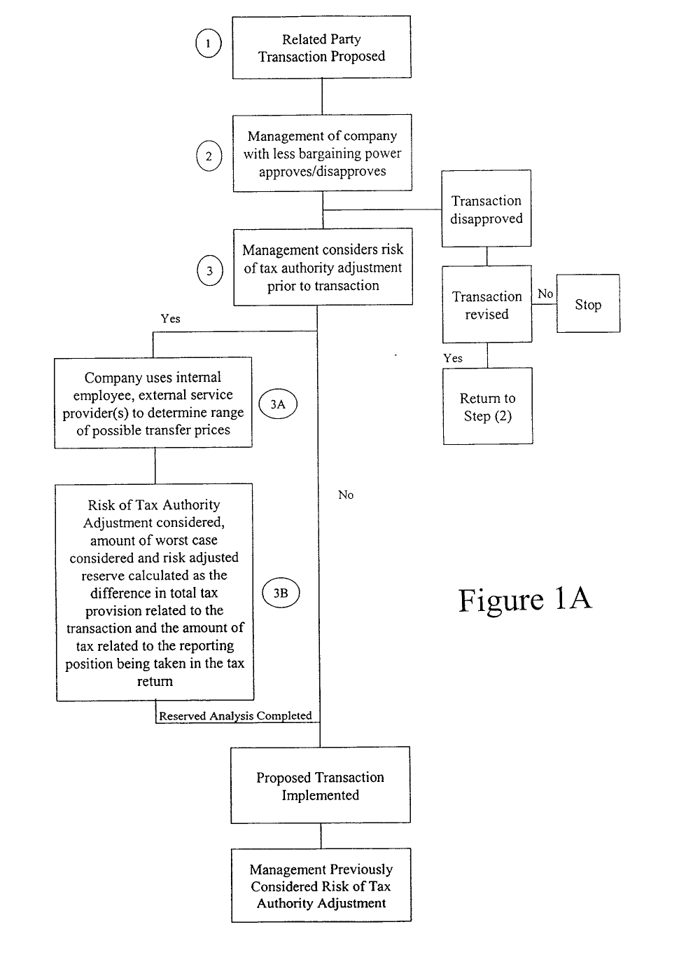

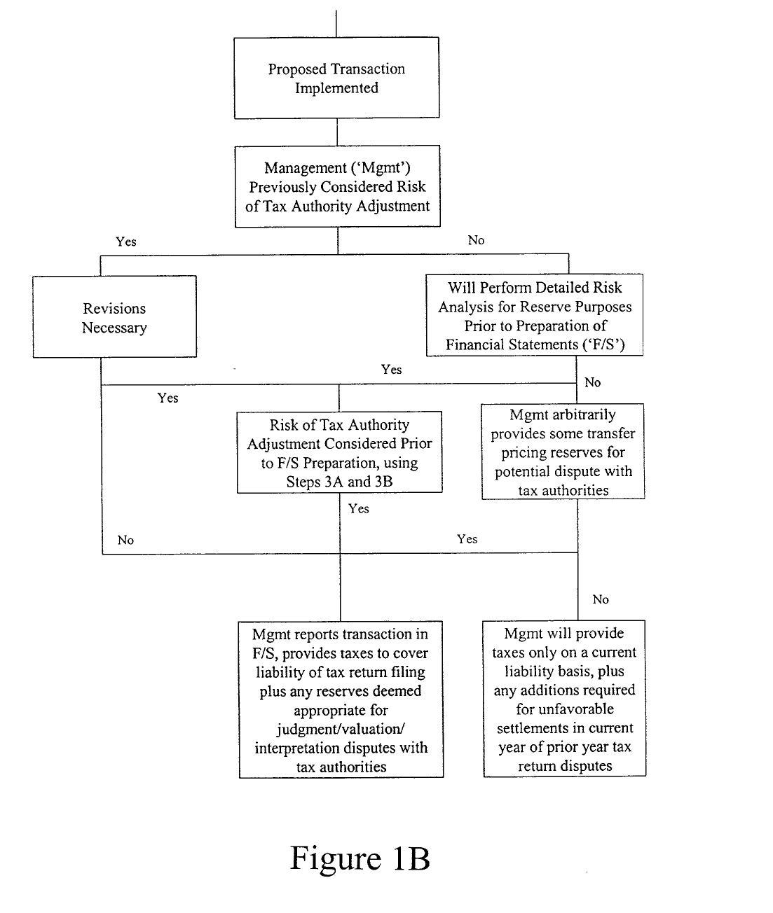

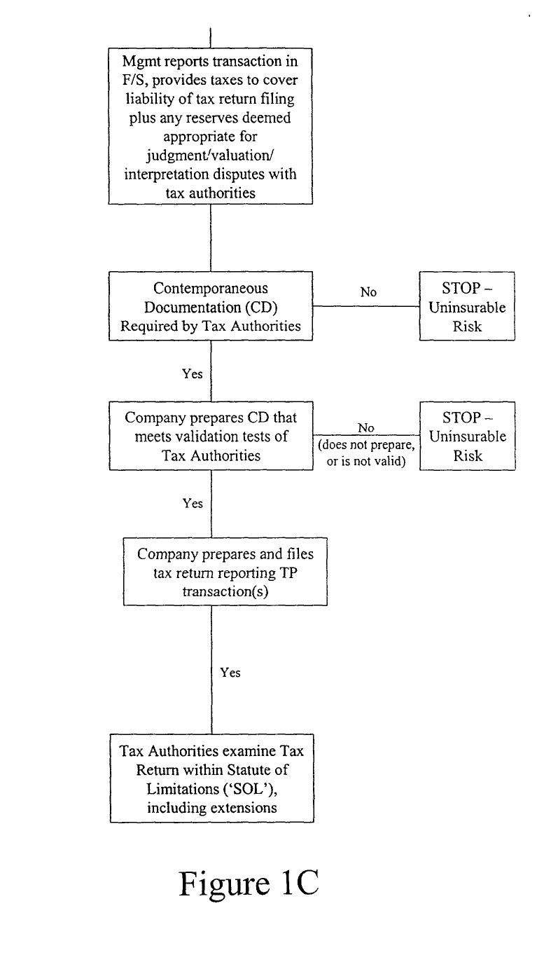

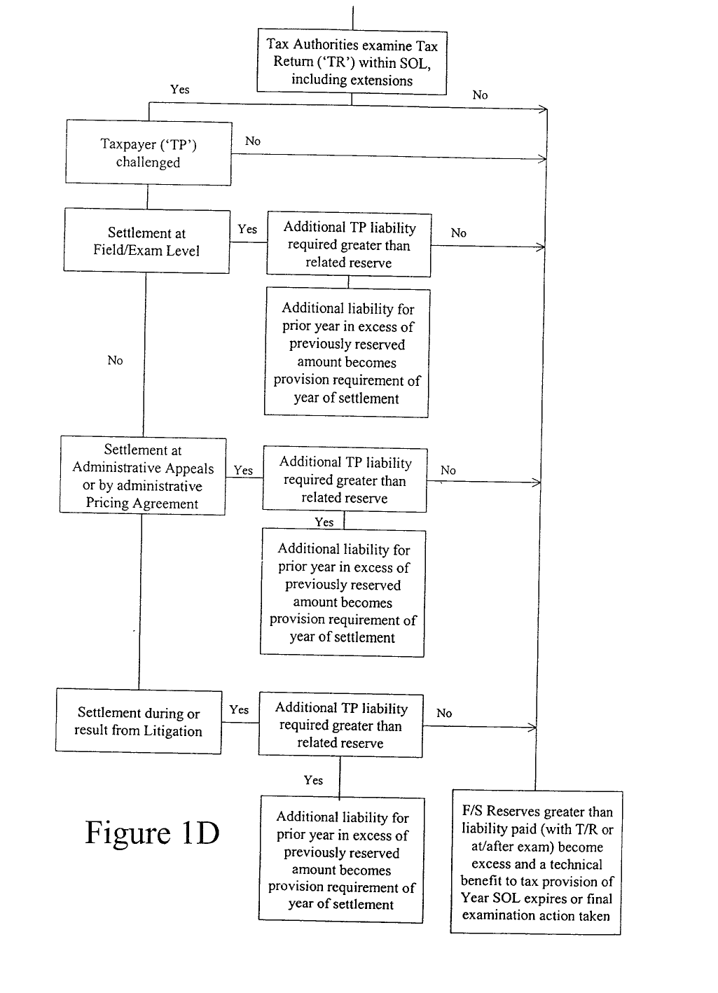

### DETAILED DESCRIPTION OF THE PREFERRED EMBODIMENT

The present invention includes a system and method for making transfer pricing insurable risk evaluation possible without waiving the company's privileged communications with legal counsel.

In one embodiment, the inventive system and method consists of four main parts: (i) an investigative questionnaire which is designed to provide a factual understanding of the subject matter being evaluated for risk; (ii) a review of the Company's Contemporaneous Documentation covering the subject matter being evaluated for risk for the specific year(s) in question; (iii) a formula setting the amount of risk the Company is required to continue to reserve for the specific subject matter in question:

[R≧X% of TPR]

Where:

R=Transfer Pricing Reserve Retention

TPR=Transfer Pricing Reserve

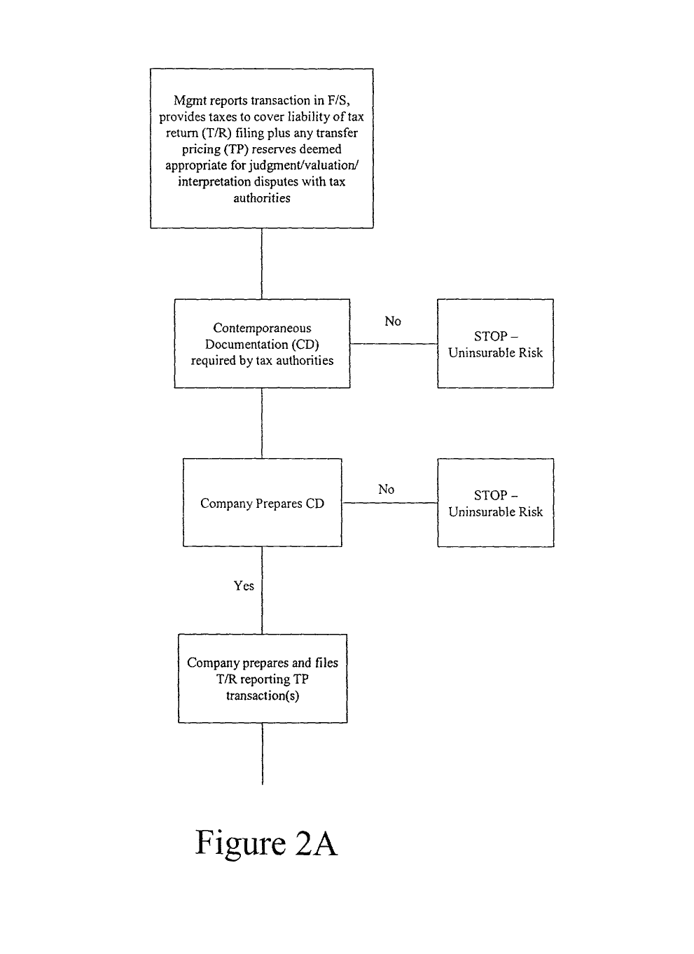

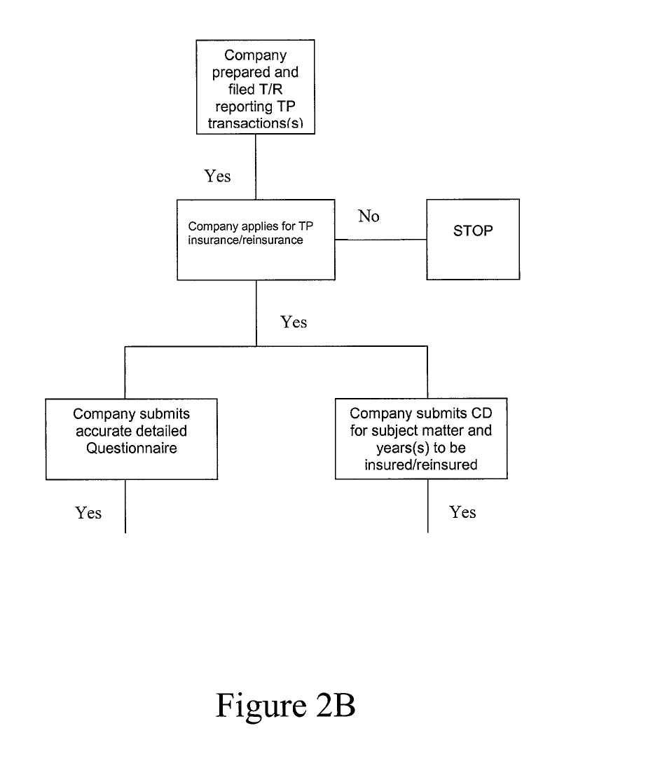

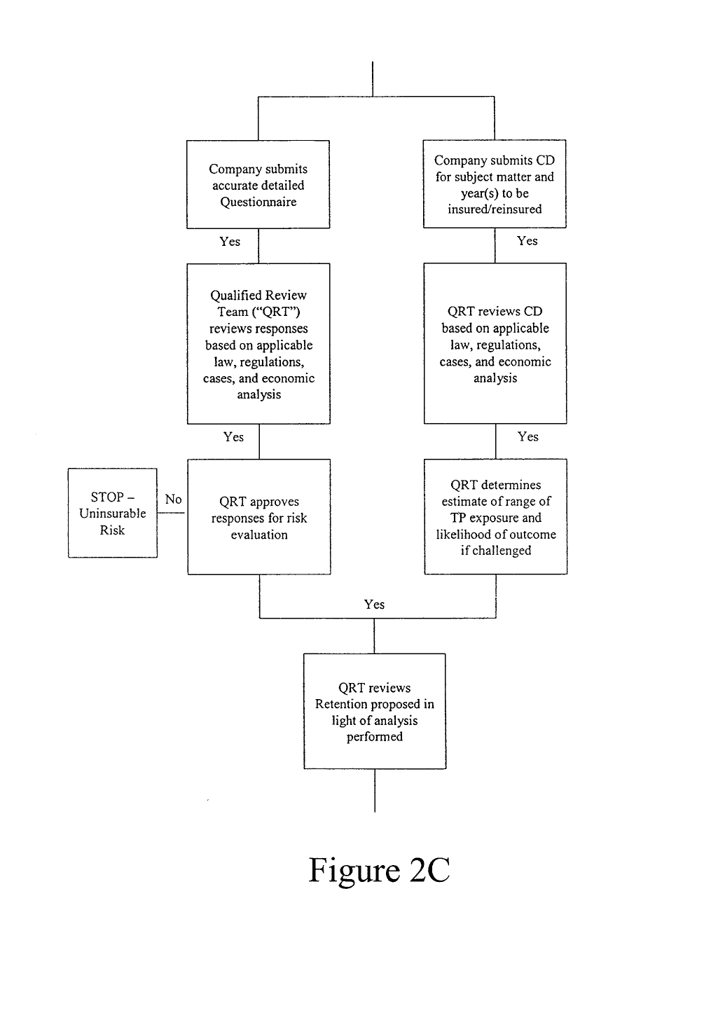

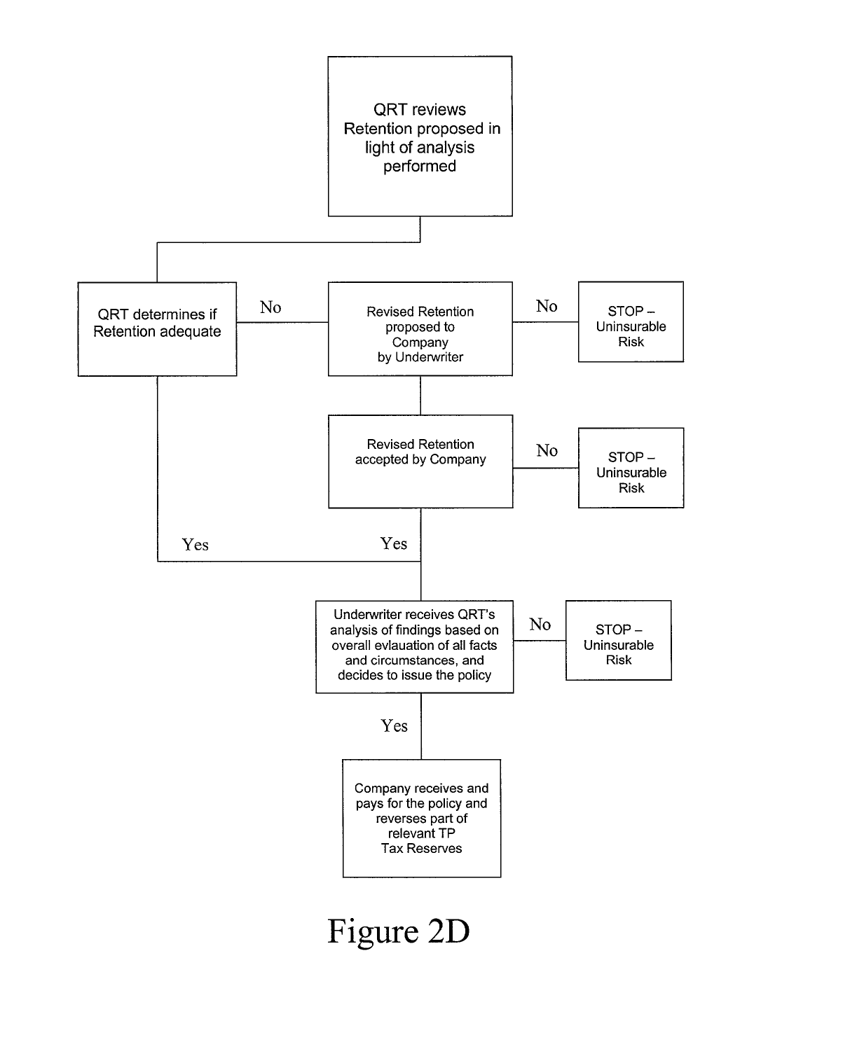

and (iv) the preparation of a transfer pricing risk evaluation report that analyzes the level of risk associated with a particular transfer pricing compliance position contained in a specific year's tax return based on the overall evaluation by a Qualified Review Team (“QRT”). An example of the method of the invention for transfer pricing risk evaluation is shown in the flow diagram of FIGS. 2A through 2D.

In a preferred embodiment, the Questionnaire develops the factual background surrounding the Company's transfer pricing subject matter, policies, and examination history in a way that does not waive the Company's privileged communications or work product privilege. For example, the Questionnaire may include questions such as:

(1) the type of items subject to transfer pricing,

(2) the dollar volume of transfer pricing transactions of the relevant entity for which transfer pricing tax reserves were established both on a gross dollar volume and profit basis,

(3) the examination history of the company with respect to transfer pricing matters on an overall basis by year for the past five years that are closed with the Internal Revenue Service as well as any disputes in progress involving any of the three years prior to the year of the subject matter.

(4) The amount disputed by the Internal Revenue Service as well as the ultimate net tax cost associated with the final resolution of the dispute by type of subject matter.

(5) The name of the outside tax advisors for transfer pricing purposes and the name of the outside economics or other firm being used for the transfer pricing studies.

(6) An audit examination length history, i.e., from the time a tax examination begins with the IRS, (a) how long does it normally take before the Service comes back with a proposed adjustment and (b) how long does it take before the matter is ultimately settled based on the company's prior closed year examination history.

Other relevant questions may be asked that will help determine the degree of risk for the particular company with respect to particular types of transactions. However, it is important to note that the amount of information that the company may disclose will of course be restricted by their great desire not to disclose anything that could lead to a violation of privilege.

In addition, in a preferred embodiment the Company provides a copy of its Contemporaneous Documentation (CD) covering the specific subject matter and years related to the relevant transfer pricing reserves whose risk is being evaluated to a Qualified Review Team (“QRT”). A QRT consists of a small group of professionals with the skill sets and experience to evaluate the risks, if any, posed by the Company's tax return reporting position on the subject matter in the relevant year(s). Minimum skills required for a QRT to properly assess the risk include experience in transfer pricing, tax law, tax accounting, economics, and as appropriate, industry skills or IRS experience. The QRT will review the CD as if it were the IRS. Here, since the CD is specifically created for the purpose of being disclosed to a third party (the IRS) by statute, the Company had no expectation of confidentiality. Therefore, the Company waives no privilege when it provides the CD to the QRT.

The formula provides for an amount of transfer pricing risk which the Company will be required to retain as part of its tax reserves. This “Retention” formula provides that the amount to Retention will be greater than or equal to a specified minimum percentage of the subject matter tax reserves for the relevant year(s).

This accomplishes two objectives. The first is that the Company will always be at risk for the first dollar of transfer pricing tax reserves. Second, the Company's retention must bear a substantive relationship to the coverage requested for the subject matter in the relevant year(s).

Finally, the transfer pricing risk evaluation report combines all of the other elements, considers the QRT analysis both in detail and over the whole of the Company's facts and circumstances, examination history, tax authority transfer pricing examination policy and history known as of the date of the QRT's analysis, and any other relevant industry, economy, company, or competitive facts or factors, in order to provide an underwriter with sufficient facts and analysis for the underwriter to decide whether to accept or reject a specific transfer pricing reserve risk related to specific subject matter and related year(s).

Another aspect of the invention provides a method for increasing earnings per share for a taxpayer. Since a tax reserve is not reported as income for financial statement purposes, where a taxpayer obtains the novel insurance policy covering a portion of its tax reserve, it may reverse that reserve to income, thereby increasing the earnings per share for the taxpayer. It is important that no privileged information needs to be disclosed in connection with obtaining the insurance.

In yet another aspect of the present invention, a method is provided for determining whether an application to insure a given amount in connection with a transfer pricing transaction for a given taxation period constitutes an insurable risk, the method comprising the steps of: obtaining from a taxpayer contemporaneous documentation related to a transfer pricing transaction; determining what publicly available information is relevant to the transfer pricing transaction; obtaining at least a portion of the relevant publicly available information; determining a transfer price range of acceptable results without reliance upon privileged information of the taxpayer, the determination being based upon information comprising the contemporaneous documentation and the obtained publicly available information; assessing a likelihood and likely magnitude of an upward adjustment to the taxpayer's income reported in connection with the transfer pricing transaction in the event that the taxpayer is examined by a tax authority; and determining whether the requested insurance amount constitutes an insurable risk in light of the assessed likelihood and likely magnitude of an upward adjustment.

The foregoing aspect may include determining an additional retention amount that would permit the requested insurance amount to constitute an insurable risk.

In another aspect of the present invention, a method is provided for determining a premium in connection with an insurance application for a requested amount of insurance and retention amount in connection with a taxable transaction for a given taxation period, the method comprising the steps of: receiving an insurance application for a requested amount of insurance and retention amount in connection with a taxable transaction for a given taxation period, the insurance application including contemporaneous documentation related to the taxable transaction; determining what publicly available information is relevant to the taxable transaction, and obtaining at least a portion of the relevant publicly available information; assessing a likelihood and likely magnitude of an upward adjustment to the taxpayer's income reported in connection with the taxable transaction in the event that the taxpayer is examined by a tax authority; and calculating a premium based, at least in part, upon the requested amount of insurance and retention amount, and the assessed likelihood and likely magnitude of an upward adjustment to the taxpayer's income reported.

In another aspect of the invention, the method of determining a premium may include obtaining a history for the taxpayer with respect to previous transfer pricing matters, for at least one previous period; determining a taxpayer risk factor relative to the history; and adjusting the premium as a function of the taxpayer risk factor.

Yet another aspect of the invention involves a method of qualifying an insurance application for a requested amount of insurance and retention amount in connection with a taxable transaction for a given taxation period, the method comprising the steps of: receiving an insurance application for a requested amount of insurance and retention amount in connection with a taxable transaction for a given taxation period, the insurance application including contemporaneous documentation related to the taxable transaction; determining what publicly available information is relevant to the transfer pricing transaction, and obtaining at least a portion of the relevant publicly available information; assessing a likelihood and likely magnitude of an upward adjustment to the taxpayer's income reported in connection with the taxable transaction; obtaining a history for the taxpayer with respect to prior taxable transactions for at least one previous period; determining a taxpayer risk factor relative to the history; calculating an expected cost of an insurance policy for the requested amount of insurance and retention amount, the expected cost being based, at least in part, upon the requested amount of insurance and retention amount, the assessed likelihood and likely magnitude of an upward adjustment to the taxpayer's income reported and the taxpayer risk factor; and qualifying the insurance application if the expected cost of the insurance policy is greater than a the premium as adjusted by a predetermined value. The predetermined value may be expressed as a percentage of the premium. In another embodiment, the percentage of the premium can varies with respect to the amount of insurance.

In another aspect of the invention, there is provided a method of performing a tax reserve risk analysis without violating the Company's privileged communication with legal counsel, the method comprising the steps of: creating a questionnaire; obtaining relevant contemporaneous documentation; analyzing the questionnaire and contemporaneous documentation for risk characteristics and quantification; implementing a formula calculation of the retention amount after performing the analysis; and providing a report of the risk evaluation.

While the invention has been particularly shown and described with reference to a preferred embodiment thereof, it will be understood by those skilled in the art that various changes in form and details may be made therein without departing from the spirit and scope of the invention.

The embodiments of the invention in which an exclusive property or privilege is claimed are defined as follows:

1. A method of increasing earnings per share for a taxpayer without revealing attorney-client or work product privileged information, the method comprising the steps of:
determining a tax reserve amount in connection with a transfer pricing transaction in a tax period;
reserving a tax reserve for financial statement purposes, the amount of the tax reserve being equal to the determined tax reserve amount;
obtaining an insurance product from an insurer, the insurance product insuring a portion of the tax reserve amount and being issued by the insurer without the insurer reviewing attorney-client or work product privileged information; and
reversing to income, for financial statement purposes, the tax reserve amount that is insured by the insurance product.

2. A method of increasing earnings per share for a taxpayer without revealing privileged information, the method comprising the steps of:
determining a tax reserve amount in connection with a taxable transaction in a tax period;
reserving a tax reserve for financial statement purposes, the amount of the tax reserve being equal to the determined tax reserve amount;
obtaining an insurance product from an insurer, the insurance product insuring a portion of the tax reserve amount and being issued by the insurer without the insurer reviewing privileged information; and
reversing to income, for financial statement purposes, at least a portion of the tax reserve amount that is insured by the insurance product.

3. The method of claim 2, wherein the taxable transaction is a transfer pricing transaction.

4. The method of claim 2, wherein privileged information that is not revealed includes attorney-client privileged information and work-product privileged information.

5. The method of claim 2, wherein the step of reversing to income comprises reversing to income, for financial statement purposes, at least a majority of the tax reserve amount that is insured by the insurance product.

6. A method of determining whether an application to insure a given amount in connection with a transfer pricing transaction for a given taxation period constitutes an insurable risk, the method comprising the steps of:
obtaining from a taxpayer contemporaneous documentation related to a transfer pricing transaction;
determining what publicly available information is relevant to the transfer pricing transaction;
obtaining at least a portion of the relevant publicly available information;
determining a transfer price range of acceptable results without reliance upon privileged information of the taxpayer, the determination being based upon information comprising the contemporaneous documentation and the obtained publicly available information;
assessing a likelihood and likely magnitude of an upward adjustment to the taxpayer's income reported in connection with the transfer pricing transaction in the event that the taxpayer is examined by a tax authority; and
determining whether the requested insurance amount constitutes an insurable risk in light of the assessed likelihood and likely magnitude of an upward adjustment.

7. The method of claim 6, further comprising the step of obtaining a desired retention amount from the taxpayer, and wherein the step of determining whether the requested insurance amount constitutes an insurable risk is further determined in light of the desired retention amount.

8. The method of claim 7, wherein, if the step of determining whether the requested insurance amount does not constitute an insurable risk, determining an additional retention amount the would be necessary for the requested insurance amount to constitute an insurable risk in light of the assessed likelihood and likely magnitude of an upward adjustment and the desired retention.

9. A method of determining a premium in connection with an insurance application for a requested amount of insurance and retention amount in connection with a taxable transaction for a given taxation period, the method comprising the steps of:
receiving an insurance application for a requested amount of insurance and retention amount in connection with a taxable transaction for a given taxation period, the insurance application including contemporaneous documentation related to the taxable transaction;
determining what publicly available information is relevant to the taxable transaction, and obtaining at least a portion of the relevant publicly available information;
assessing a likelihood and likely magnitude of an upward adjustment to the taxpayer's income reported in connection with the taxable transaction in the event that the taxpayer is examined by a tax authority; and
calculating a premium based at least in part upon the requested amount of insurance and retention amount, and the assessed likelihood and likely magnitude of an upward adjustment to the taxpayer's income reported.

10. The method of claim 9, wherein the taxable transaction is a transfer pricing transaction.

11. The method of claim 9, further comprising the steps of:
obtaining a history for the taxpayer with respect to previous transfer pricing matters, for at least one previous period;
determining a taxpayer risk factor relative to the history; and
adjusting the premium as a function of the taxpayer risk factor.

12. A method of qualifying an insurance application for a requested amount of insurance and retention amount in connection with a taxable transaction for a given taxation period, the method comprising the steps of:
receiving an insurance application for a requested amount of insurance and retention amount in connection with a taxable transaction for a given taxation period, the insurance application including contemporaneous documentation related to the taxable transaction;
determining what publicly available information is relevant to the transfer pricing transaction, and obtaining at least a portion of the relevant publicly available information;
assessing a likelihood and likely magnitude of an upward adjustment to the taxpayer's income reported in connection with the taxable transaction;
obtaining a history for the taxpayer with respect to prior taxable transactions for at least one previous period;
determining a taxpayer risk factor relative to the history;
calculating an expected cost of an insurance policy for the requested amount of insurance and retention amount, the expected cost being based at least in part upon the requested amount of insurance and retention amount, the assessed likelihood and likely magnitude of an upward adjustment to the taxpayer's income reported and the taxpayer risk factor; and,
qualifying the insurance application if the expected cost of the insurance policy is greater than a the premium plus a predetermined value.

13. The method of claim 12, where in the predetermined value is a percentage of the premium.

14. The method of claim 13, where in the percentage of the premium varies with respect to the amount of insurance.

15. A method of performing a tax reserve risk analysis without violating the Company's privileged communication with legal counsel, the method comprising the steps of:
creating a questionnaire;
obtaining relevant contemporaneous documentation;
analyzing the questionnaire and contemporaneous documentation for risk characteristics and quantification;
implementing a formula calculation of the retention amount after performing the analysis; and,
providing a report of the risk evaluation.
